(19) United States
(12) Patent Application Publication
(10) Pub. No.: US 2012/0198238 A1
(43) Pub. Date: Aug. 2, 2012

(54) METHOD FOR ESTABLISHING AN ELECTRONIC AUTHORIZATION FOR A USER BEARING AN ELECTRONIC IDENTITY DOCUMENT, AND METHOD FOR SUPERVISING SAID AUTHORIZATION

(75) Inventor: Bruno Rouchouze, St Cyr Sur Mer (FR)

(73) Assignee: GEMALTO SA, Meudon (FR)

(21) Appl. No.: 13/392,046

(22) PCT Filed: Aug. 11, 2010
(86) PCT No.: PCT/EP2010/061706

§ 371 Date: Feb. 23, 2012

(30) Foreign Application Priority Data
Aug. 24, 2009 (EP) 09305782.6

(51) Int. Cl. H04L 9/32; H04L 9/28

(52) U.S. Cl. 713/176

(57) ABSTRACT

The invention relates to a method for generating and validating a digital authorization request, as well as to the method for supervising said authorization. The method of invention enables the guarantee, due to a combination of a series of signatures, at any time, of the identity of the bearer of the document and of the validating body.

The invention relates to a method for establishing an electronic authorization.

The invention more particularly relates to establishing authorizations linked with an electronic document.

More and more places request access authorizations. Such places are, for instance, confidential areas such as electronic archiving areas, or areas considered as presenting a trespassing risk: airport areas, politico-military areas.

In all such places, it is necessary to know who is present, at any time, and of course to be sure that the present persons really are those having received the authorizations to be there.

So far, it has been relatively easy to check the identity documents that a person may show, and thus to check his/her identity, but it is much more difficult to be sure that an authorization really corresponds to one person.

The exponential increase of peoples' migrations on the planet results in the circulation of identity documents, and makes the checking of the documents validity much more difficult.

As a matter of fact, in the same country, several types of documents may be considered as identity documents: a passport, an identity card, a driver's license, a family record book . . . , and this list of documents should be multiplied by as many countries and different evolutive versions in each country, and thus in geographical areas such as Europe, potential identity documents can be counted by dozens, and on the world scale, several hundreds of documents can be considered as perfectly legal.

In such a context, checking that an authorization has been given on the basis of such or such of these documents becomes very difficult.

Various solutions can be considered for solving such a problem. For instance:

Reinforced training of supervising officers in the various types of existing identity documents,

Live validation of the identity documents with the entities in charge of implementing the document.

Such approaches are not very realistic, however, and can hardly be applied.

As a matter of fact, the first solution requires a continuous training in order to study any new identity document issued, and in order to know each potential risk or default demonstrated with respect to each type of issued document. The existence of more than 120 types of driver's licenses in the 27 countries of the European Union alone shows how such an approach could hardly be conceived, all the more so on the world scale.

The second solution depends on whether the issuing authorities will accept to answer in due time a request for validation of one of the issued documents. This requires, in addition to an uninterrupted connexion between all the potential checking points and all the authorities issuing documents, a security approval by an external, or even a foreign entity. Risks remain, and more particularly those relating to massive exchanges of information. This inevitably generates problems in the management of persons' privacy.

In addition, the plurality of documents for the same person may entail hazardous situations.

For instance, a person may take an international flight, using one identity document, and enter the destination country using another document. This is particularly true within the scope of double nationalities. Thus a French-American person may take off from Paris, and show his/her French passport and land in New-York and show his/her American passport.

In this context, the boarding authorization, issued on the basis of the French passport, becomes null and void.

All check points may not be trained enough to be able to check whether an identity document is true. Using a fraudulent identity may thus become reality and thus may be significantly harmful.

The present invention provides to give an electronic solution to this potential security default, while providing the bearer with a more comfortable use.

For this purpose, the invention provides a method for generating and validating a request for a digital authorization, as well as the method for supervising said authorization. The method according to the invention enables the guarantee, due to a combination of a series of signatures, at any time, of the identity of the bearer of the document and of the validating body.

More precisely, the invention firstly describes:

A method for establishing an electronic authorization relating to a so-called eID electronic identity document, including at least a couple of so-called UtilPriv and UtilPub private/public keys, as well as an asymmetric encryption ASYM algorithm, with said document being able to communicate with a second so-called server electronic device, including at least a couple of so-called ServPriv and ServPub private/public keys, as well as an asymmetric encryption ASYM algorithm.

Such method includes at least the following steps:
generation of a digital “object” called an eRequest,
signature of the eRequest using the UtilPriv key and the ASYM algorithm,
transmission of the signed eRequest to the server,
checking of the signature of the eRequest, by the server, using the UtilPub key, as well as the ASYM algorithm,
generation, by the server of a digital “object”, called an eAuthorization,
signature of the eAuthorization by the server, using the ServPriv private key and the ASYM algorithm,
transmission of the signed eAuthorization, from the server, to the eID document.

Upon receiving the signed eRequest, the server may store it in a non volatile memory.

The signed eAuthorization may be stored in a non volatile memory accessible by the eID document, for instance in a non volatile memory contained in the eID document.

The signed eAuthorization may be stored in a non volatile memory accessible by the server, for instance in a non volatile memory contained in the server.

The digital “object” called eAuthorization may include whole or part of the information contained in the eRequest, as well as at least one piece of information on the acceptance of such request.

During a previous step, the bearer of the eID document may authenticate himself/herself with the eID document, for instance using a personal code.

Secondly, the invention discloses a method for taking into account an electronic authorization, the eAthorization, relating to a so-called eID electronic identity document, including at least a couple of so-called UtilPriv and UtilPub private/public keys, as well as an asymmetric encryption ASYM algorithm, with the document being able to communicate with a second so-called terminal electronic device, including at least an access to the UtilPub, of the eID document, and SerPub public keys of the ServPriv and ServPub couple of a so-called server third party electronic device, as well as an asymmetric encryption ASYM algorithm, with the eAuthorization being signed using the ServPriv key, and including at least one request, signed using the Utilpriv key, as well as at least one piece of information on the acceptance of such request,

The method includes at least the following steps:
transmission of an eAuthorization object, from the eID document to the terminal,
checking of the signature of all or part of the data contained in the eAuthorization, using the UtilPub key, as well as the ASYM algorithm,
checking of the signature of the eAuthorization, using the ServPub key, as well as the ASYM algorithm,
analysis of the information contained in the eAuthorization,
decision to validate or not the content according to the results of the checking.

Other characteristics and advantages will appear more clearly when reading the following description and referring to the appended drawings, wherein:

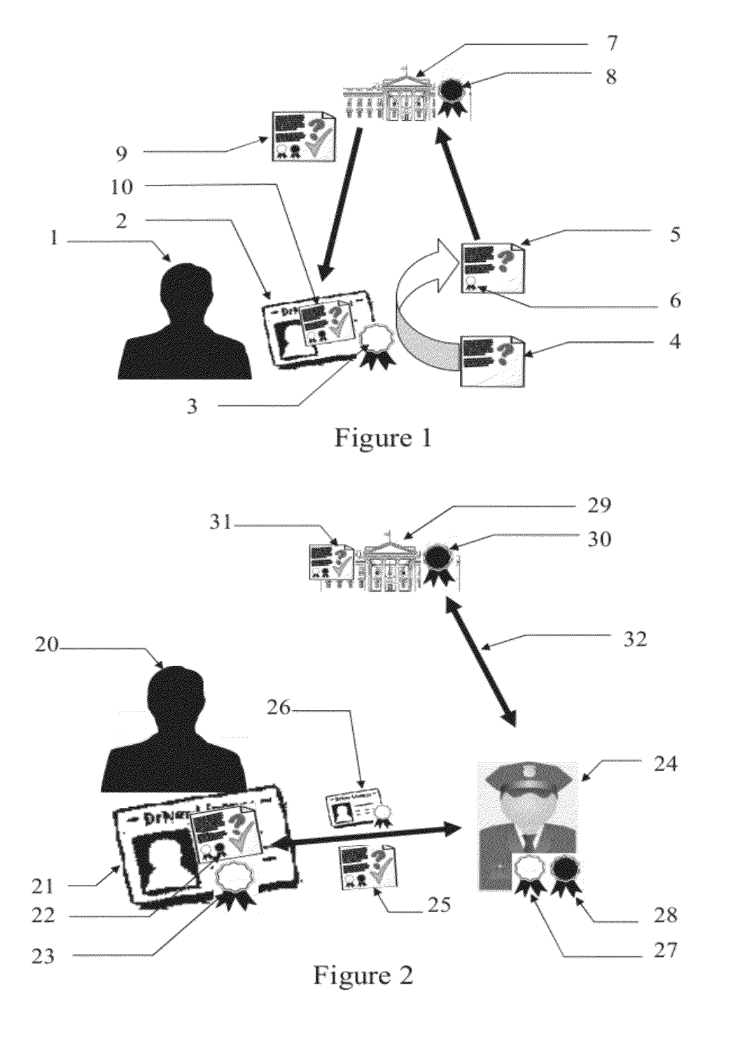

FIG. 1 shows the establishment of an authorization according to the invention.

FIG. 2 shows the checking of an authorization according to the invention.

In the present description, the invention will be described in the particular context of an access to a plane. The present invention can be applied in a similar way to any type of authorization, whether this authorization is linked to a physical access, or a virtual access, for instance an access to electronic documents.

The electronic identity document which will be used for illustrating the operation of the invention in the present description can be virtualized.

In FIG. 1, a person 1 requests access to a plane. For this purpose, upon checking-in at the airport counter, the user 1 shows a passport 2, provided with an electronic chip, containing at least a certificate PKI 3.

The checking point prepares, according to the data mentioned on the user's ticket, a request for a boarding authorization 4. Such request includes, among other things, the flight number, the booked seat, the time and place of the taking off and the landing. Such request for a boarding authorization is sent to the passport 2 chip, which signs it. The signature is made using an encryption algorithm and a key.

The boarding point is used as a relay between the electronic document and the other actors in the system. In the case where the identity document is materialized by a communicating electronic device (a mobile telephone, or a communicating electronic pager . . . ) or aboard such a device, its presence is not necessary.

In a preferred embodiment of the invention, the algorithm used is an asymmetric algorithm, for instance the RSA (for Rivest, Shamir and Adleman) algorithm.

Asymmetric encryption or public key encryption is founded on the existence of irreversible functions.

Thus public key encryption is an asymmetric method using a pair of keys. Such keys, generally called “public key” and “private key”, are so formed that what is enciphered using one of the keys cannot be deciphered but by the second one.

The principle thus consists in distributing the public key while keeping the private key secret. Any user having a copy of the public key will be able to encipher the information that the owner of the private key will be able to decipher, alone.

It should be noted that deducing the private key from the public key is impossible.

The generation of the public key/private key couples, is not the object of the present invention. All the methods disclosed by the state of the art, or the future ones, which make it possible to obtain such a couple of keys can be applied to the present invention.

Thus in the case of the embodiment illustrated in FIG. 1, the passport 2 contains, in the electronic chip thereof, at least one asymmetric encryption algorithm, as well as the user's 1 public and private keys. The signature 6 is executed using this algorithm and the user's private key 3.

This request for a boarding authorization is sent to a reliable third party 7.

This reliable third party is also called the server, because of the position thereof in the system. In the remainder of the document, the terms “reliable third party” and “server” both equally indicate the same entity.

In our boarding context, the reliable third party can advantageously be an entity of the air and border police, or the customs. The reliable third party's mission consists in validating or not the authorization to board, and to stamp such an authorization.

The reliable third party must further be provided with its own electronic signing means, as well as the means for checking the electronic signatures, for instance, the users' ones.

In the embodiment based on an asymmetric encryption algorithm, the reliable third party must have its own set of private/public keys, but also the users' public keys.

In another embodiment, the invention may rely on a secret key encryption diagram (also called a symmetric encryption algorithm).

The asymmetric encryption, or secret key encryption, is based on the shared knowledge of a secret between two actors.

The algorithms used, such as for example, the DES, 3DES, AES, . . . rely on the fact that it is almost impossible to find the clear message, if you know the enciphered version of a message, but do not know the key used for the enciphering thereof.

The essential role played by the key in the diagrams justifies the implementation of numerous satellite mechanisms in order to guarantee the confidentiality thereof.

In our boarding context, the diagram requires the reliable third party and the user's electronic passport to share a secret. It is highly recommended that the secret should be limited to only one user, and that it should be different for several users.

In a preferred embodiment of the invention, prior to establishing the request for authorization, the electronic chip of the user's passport 2 comes into direct contact with the reliable third party 7, and authenticates with it. Such an authentication aims at demonstrating the validity of the document shown, as well as the legitimacy of the owner thereof. Electronic certificates may be used for authenticating the document shown, the potential utilization of an external element, for example a secret code, may make it possible to legitimate the bearer.

This authentication can be made with any one of the authentication algorithms known to the specialists.

Upon completion of the request for authorization 4, and its signature by the passport 2 electronic component, a signed request for authorization 5 is obtained. Such request must be transmitted to the reliable third party 7 for validation purposes.

If the reliable third party is provided with means for checking the validity of the signature 6, the latter is checked. Such operation makes it possible, not only to check the signatory's identity (or at least that of the passport 2), but also to check that the request 5 has not been modified since it was signed. As a matter of fact, if all or part of the document 5 has been modified, the electronic signature 6 shall become null and void.

If the checking of the signature is correct, the reliable third party 7 studies the content of the request for authorization 5, and makes a decision. In the illustrated case of FIG. 1, the reliable third party accepts the request for boarding. The approval thereof is notified on the request for authorization which thus becomes a valid authorization 9. Such an authorization is in turn signed by the reliable third party and sent back to the passport 2 electronic component, which saves it 10.

In a particularly interesting embodiment, the reliable third party keeps, in a non volatile memory, a copy of the valid authorization 9.

The authorization has been established as a function of a user 1, an electronic identity document 2, content 4 and a reliable third party 7.

The above four elements are inextricably interconnected in the authorization 10. The strength of such an authorization lies, among other things, in that, upon any subsequent checking, each one of such four parameters shall be easily checked.

FIG. 2 illustrates the checking of an authorization 22 by an officer 24.

The officer may be a physical person as a security officer, or an automatic module, for instance a computer programme or an electronic module (check point). In all cases, the officer must be provided with an electronic device (also called a terminal), able to read the electronic components in the passport 21.

In our exemplary implementation upon boarding, the checking operation can be executed when boarding the plane or when disembarking. The remainder of the text will be dedicated to the exemplary checking upon disembarking the plane.

The user 20 must show his/her valid authorization to be allowed to disembark the plane. For this purpose, he/she shows 26 the officer 24 his/her identity document equipped with an electronic component, and recorded in a non volatile memory, having a valid authorization 22 established according to the invention.

The officer 24 retrieves 25 the authorization 22 as well as the means 27 for checking the user's signature, as executed on the authorization 22.

An authentication is requested from the user, in order to demonstrate the bearer's legitimacy, and the validity of his/her identity document 21. The officer 24 can now check the validity of the signature executed on the authorization. In the case where such a checking is correctly executed, the officer 24 is now sure that the authorization has not been modified, and that it has really been established using the document 21 shown, and by the bearer 20.

This makes it possible to solve the case where a user owns several identity documents, and disembarks using a document different from the one shown upon boarding.

The officer 24 must, from now on, check the signature executed on the authorization by the reliable third party which issued such an authorization. Several possibilities exist: either he/she has been provided with a means 28 for checking such signature, or he/she is in touch with a reliable third party 29, which owns such checking means 30. It should be noted that this reliable third party is not necessarily identical with the one which issued such an authorization, as illustrated in FIG. 1. In most cases, such reliable third parties are entities independent from each other, but having committed themselves into agreements providing a mutual reliance.

In order to obtain the maximum security level, all exchanges between the various electronic actors can be secured by applying the specialists' mechanisms; and more particularly, by establishing secured channels.

1. A method for establishing an electronic authorization relating to an electronic identity document (eID), including public and private keys and an asymmetric encryption algorithm, with said document being configured to communicate with a server electronic device, including public and private keys and an asymmetric encryption algorithm,
said method including the following steps:
generation of a digital object called an eRequest,
signature of said eRequest using said eID private key and said asymmetric algorithm,
transmission of the signed eRequest to the server,
checking the signature of said eRequest, by said server, using said eID public key, as well as said asymmetric algorithm,
generation, by the server, of a digital object, called an eAuthorization,
signature of said eAuthorization by said server, using said server private key and said asymmetric algorithm, and
transmission of said signed eAuthorization, from said server, to said eID.

2. A method according to claim 1, wherein, upon receiving said signed eRequest, said server stores the signed eRequest in a non-volatile memory.

3. A method according to claim 1, wherein said signed eAuthorization is stored in a non-volatile memory accessible by said eID.

4. A method according to claim 3, wherein said non-volatile memory is contained in said eID.

5. A method according to claim 1, wherein said signed eAuthorization is stored in a non-volatile memory accessible by said server.

6. A method according to claim 5, wherein said non-volatile memory is contained in said server.

7. A method according to claim 1, wherein said eAuthorization includes a whole or part of the information contained in said eRequest, as well as at least one piece of information on the acceptance of such request.

8. A method according to claim 1, wherein, during a previous step, a bearer of said eID authenticates himself/herself with said eID.

9. A method according to claim 8, wherein said authentication is executed using a personal code.

10. A method for taking into account an electronic authorization (eAthorization), relating to an electronic identity document (eID), including private and public keys, as well as an asymmetric encryption algorithm, with said document being configured to communicate with a terminal electronic device, including at least an access to the public key of said eID, and public keys of a public/private key pair of a third-party electronic device, as well as an asymmetric encryption algorithm, with said eAuthorization being signed using the private key of said third-party electronic device, and including at least one request, signed using said private key of the eID, as well as at least one piece of information on the acceptance of such request,
said method including the following steps:
transmission of an eAuthorization object, from said eID document to said terminal,
checking of the signature of all or part of the data contained in said eAuthorization, using said public key of the eID, as well as said asymmetric algorithm,
checking the signature of said eAuthorization, using said public key of the third-party electronic device, as well as said asymmetric algorithm,
analysis of the information contained in said eAuthorization, and
deciding whether to validate said content according to the results of said checking.
